(19) United States
(12) Patent Application Publication
(10) Pub. No.: US 2015/0182403 A1
(43) Pub. Date: Jul. 2, 2015

(54) A Mobile Robotic Lifting and Transferring System for Bariatric Patients

(71) Applicants: Yi-Je Lim, Boxborough, MA (US); Jianjuen Hu, Boxborough, MA (US); Harrison Roberts, Boxborough, MA (US); Suzana Makowski, Grafton, MA (US)

(72) Inventors: Yi-Je Lim, Boxborough, MA (US); Jianjuen Hu, Boxborough, MA (US); Harrison Roberts, Boxborough, MA (US); Suzana Makowski, Grafton, MA (US)

(21) Appl. No.: 14/146,472

(22) Filed: Jan. 2, 2014

(51) Int. Cl. A61G 7/10

(52) U.S. Cl. CPC A61G 7/1013; A61G 7/1025; A61G 7/1001; Y10S 901/01

(57) ABSTRACT

Obesity has grown into one of the world's most significant health problems. The field of bariatrics and the quantity of bariatric surgical procedures is projected to continue to increase rapidly each year. This trend presents a challenge to healthcare providers and facilities striving to provide dignified care that is effective and safe both for the patient and the provider. There is a great demand for new approaches to bariatric patient care. The present invention is a robotic patient lifting system, targeted for, but not limited to, bariatric patient care. Without the need for difficult, time consuming slings and hoists associated with currently available systems, the invented lifting and transferring system utilizes rapidly deployable, articulated robotic arms with gentle conveyor belts. A unique linkage system allows powerful, safe, and flexible lifting and positioning of the patient with a minimal number of actuators. The lifting mechanism is mounted on a low profile, stable and flexible footprint, omnidirectional robotic mobile base. A simple, intuitive user interface allows control by a single caregiver with minimal training

### CROSS-REFERENCE TO RELATED APPLICATIONS

The present Utility patent application claims priority benefit of the U.S. provisional application for patent Ser. No. 61/754,395 filed on Jan. 18, 2013 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to robots or mechanisms. More particularly, one or more embodiments of the invention relate to medical or service robots.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a robot is a mechanical or virtual intelligent agent that can perform tasks automatically or with guidance, typically by remote control. In practice a robot is usually an electro-mechanical machine that is guided by computer and electronic programming. By mimicking a lifelike appearance or automating movements, a robot may convey a sense that it has intent or agency of its own. More importantly, a robot working with caregiver and patient should be also able to cooperate with human safely which is significantly different from those industrial robots constrained in a protected area.

Typically, a wide range of mechanical lifting and transfer solutions have evolved to enable safe patient lifting and handling.

Typically, increasing prevalence of overweight and obesity in the world corresponds to a marked increase in the number of bariatric patients admitted to healthcare facilities and growing demand for bariatric, or weight-reduction, surgery. Many bariatric patients require assistance with numerous activities of daily living, thus bringing risk of injury to those providing care. The human workforce does not have the same capacity to service the bariatric patients as a robotic device would. The time and effort needed are great.

Typically, all current commercially available lifting devices require the patient and/or his limbs to be put in or on top of a fabric sling. The sling is then attached to cables and hoisted by a ceiling-based device or a freestanding structure on a wheeled base. These devices require inflexible design into hospital construction, bring positioning hazard resulting in falls and strain for the patient and the lifting teams, and need nurses and lifting teams taking staff time from other duties to move the apparatus into position for each lift which is very inconvenient.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary robotic system that is positioned to lift, but not limited to, a bariatric patient or a heavy object, in accordance with an embodiment of the present invention.

FIG. 2 illustrates an exemplary robotic system utilizing a pair of manipulation arms to lift a bariatric patient with an embodiment of the present invention.

FIG. 3a illustrates exemplary robotic manipulation arms using conveyor system in an extended position, linked together and attached to three vertical linear actuators, in accordance with an embodiment of the present invention;

FIGS. 3b and 3c illustrate detailed perspective views of exemplary manipulation arms in relation to robotic system, in accordance with an embodiment of the present invention.

FIGS. 3d and 3e illustrate detailed perspective views of an exemplary robotic manipulation arm that has an articulated flipper with a soft conveyer belt in relation to medical robotic system, in accordance with an embodiment of the present invention, where FIG. 3d illustrates the flipper straightening with the lifting arm surface, and FIG. 3d illustrates the flipper rotated up to provide a secure safety stop.

FIGS. 4a and 4b illustrate an exemplary vertical actuator assembly encased with the linkage system, in accordance with an embodiment of the present invention.

FIG. 5a illustrates the movement of linear actuators relative to one another changing the vertical position and relative angle of the arms, in accordance with an embodiment of the present invention.

FIG. 5b illustrates that the patient's position can be changed safely and comfortably from prone, to tilted, to reclined, to sitting at a 90 degree angle.

FIG. 5c illustrates moving the linear actuators in unison allowing the robot to lift and lower the patient using the power of all three vertical linear actuators combined.

FIG. 6 illustrates safety straps to secure the patient and prevent him or her from sliding off the device, in accordance with an embodiment of the present invention.

FIG. 7a illustrates low profile, small footprint, omnidirectional base which lifting mechanism is mounted on, in accordance with an embodiment of the present invention.

FIG. 7b illustrates detailed perspective view of an exemplary drive track that expands to provide a wide base for stability and access to wheelchair for the medical robotic system, in accordance with an embodiment of the present invention.

FIG. 8 illustrates an operation control unit, in accordance with an embodiment of the present invention;

FIG. 9 illustrates a modular, extensible system architecture, in accordance with an embodiment of the present invention.

FIG. 10 illustrates a typical computer system that, when appropriately configured or designed, can serve as a computer system in which the invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

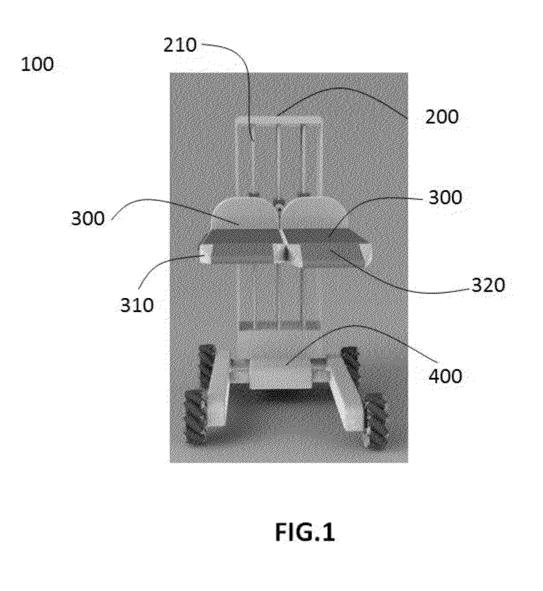

FIGS. 1 through 10 illustrate some exemplary embodiments and various views of a bariatric patient care robotic system (100) and numerous components of robotic system, in accordance with at least one embodiment of the present invention. One embodiment of the present invention may include a robotic system that services a patient (500) in a medical facility. The medical robotic system may service patient, and traverse through the medical facility by a medical professional. Some embodiments of the present invention may have a holonomic drive system (400) for easy maneuverability in a hospital setting, an intuitive interface for human-robot interaction (600), and manipulation arms (300) having sufficient strength to lift and move patients and heavy loads up to, but not limited to, 1,000 lbs. In some embodiments, robotic system may include numerous components that are integrated together. Some of the major components may include, without limitation, at least one bimanual lifting and transferring manipulator (300), a linkage system (200), a drive track (400) with holonomic drive capabilities, an interface for human-robot interaction, and a highly integrated plan for healthcare system integration.

FIG. 1 illustrates an exemplary robotic system that is positioned to lift a bariatric patient or a heavy object, in accordance with an embodiment of the present invention. In embodiment shown (100), the robotic system assists a medical professional with reducing the medical professional's exposure to back pain or injury from heavy lifting, transferring heavy objects, and carrying medical supplies. The medical robotic system may also provide numerous capabilities efficacious for servicing patients in a medical facility, including but not limited to: safely maneuvering bariatric patients in tight spaces within a hospital environment (e.g., OR, patient room, etc.), interacting with a patient and a nurse, working safely and robustly with a nurse, providing an easy-to-use interface without significant preparation time, safely lifting and transferring patients, providing a motorized wheelchair feature for short distance transportation, and working under direct nurse command or patient self-operation. In alternative embodiment, the medical robotic system may perform functions in a medical facility store house, such as, but not limited to, stocking medication, discarding waste, and taking inventory.

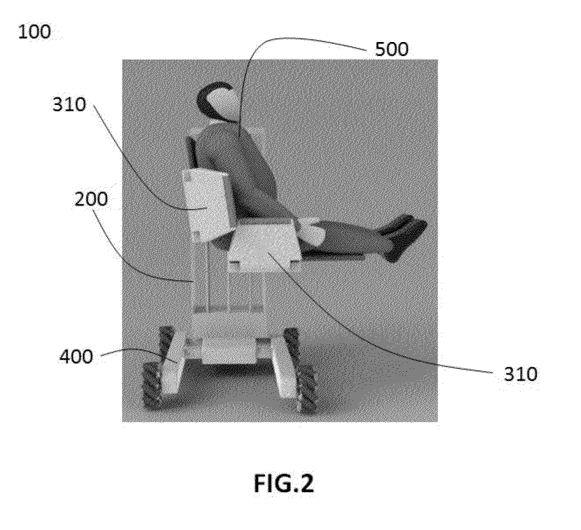

FIG. 2 illustrates an exemplary robotic system utilizing a pair of manipulation arms (300) to lift or transfer the patient (500) with an embodiment of the present invention. In the embodiment shown (100), the invented robotic system may approach the patient in bed, either by means of voice command or operating through an operation control unit. The robot slowly drives forward sliding its lifting arms (300) under the patient. The arms move forward at the same speed as the reverse rotation of the belts (320). This eliminates any relative motion between the patient's skin and the surface of the arm that might make insertion difficult and/or possibly cause discomfort to the patient.

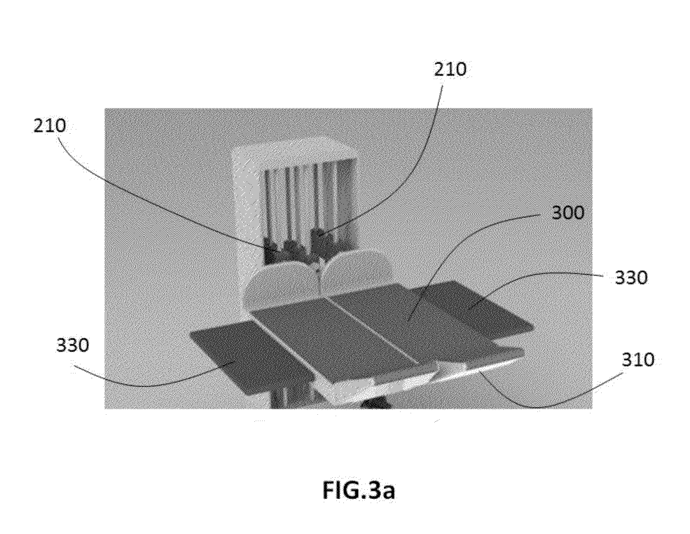

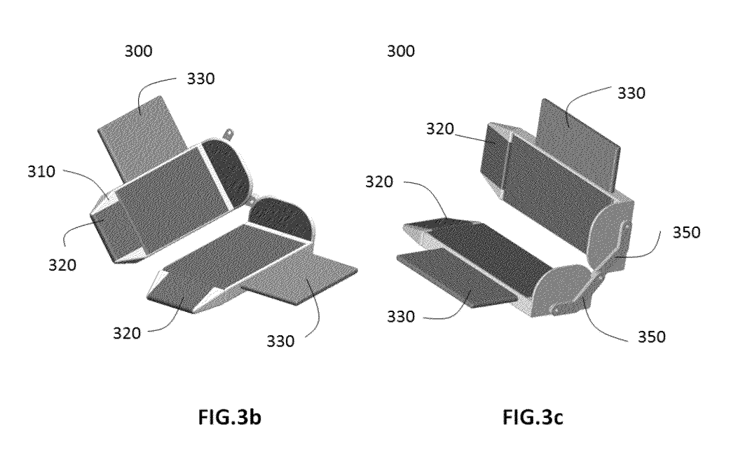

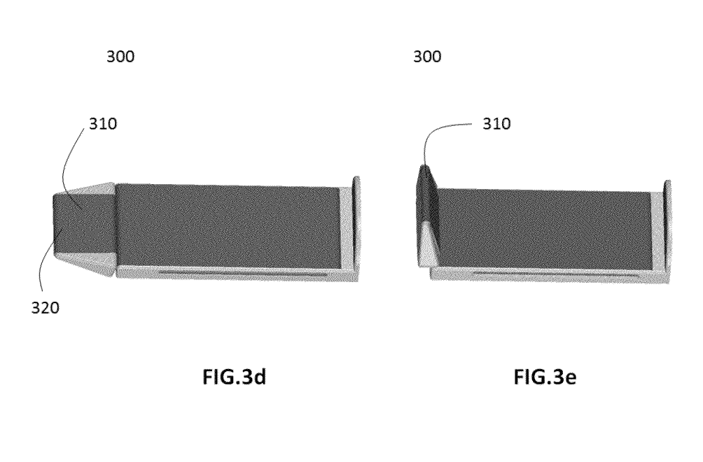

FIG. 3a illustrates an exemplary manipulation arms (300) using conveyor system (320) in an extended position, linked together and attached to three vertical linear actuators (200) by a linkage system, in accordance with an embodiment of the present invention. A vertical actuator assembly (200) attached to robotic manipulation arms (300) provides sufficient power to lift a heavy object, including but not limited to, a bariatric patient.

FIGS. 3b and 3c illustrate detailed perspective views of exemplary robotic lifting arms (300) in relation to medical robotic system, in accordance with an embodiment of the present invention. In the embodiment shown (300), the arms are two large, wedge shaped manipulators with soft conveyor belt surfaces (320) covering the entire top half. When the lifting arms (300) are completely under the patient, smooth extension surfaces (330) gently emerge from the outward sides of the arms (300) to help fully support the patient's neck and legs. In some embodiments, the robot arm (300) may comprised of reverse-motion belts on these extended supporters (330) to avoid skin shear, especially under very heavy thighs and calves.

FIGS. 3d and 3e illustrate detailed perspective views of an exemplary robotic lifting arm (300) that has an articulated flipper (310) with a soft conveyer belt (320) in relation to medical robotic system, in accordance with an embodiment of the present invention, where FIG. 3d illustrates the flipper straightening with the lifting arm, and FIG. 3d illustrates the flipper rotated up to provide a secure safety stop, thereby preventing the patient from rolling off. In some embodiment, the flippers (310) may also have the additional function of assisting in the insertion of the lifting arms under the patient. By gently rotating up and down slightly while the arms (300) move forward, the flippers (310) may help insertion by mimicking the way nurses use their hands to “inch” their arms under a patient.

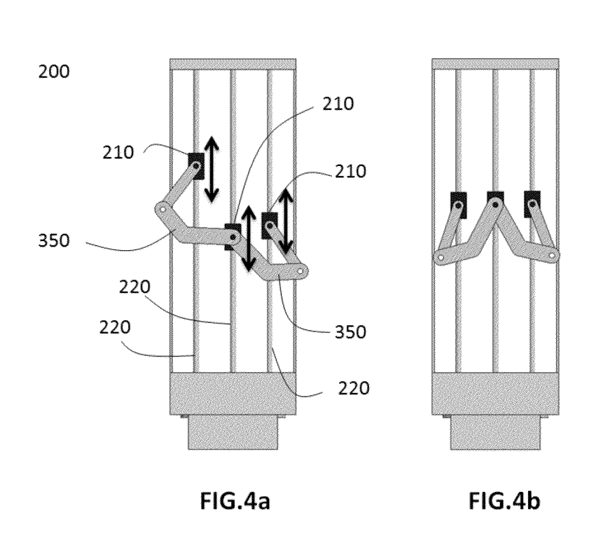

FIGS. 4a and 4b illustrate an exemplary vertical actuator assembly (200) encased with the linkage system (210), in accordance with an embodiment of the present invention. The linkage system (210) allows powerful, safe, and flexible lifting and positioning of the patient with a minimal number of actuators. In the present embodiment, actuator assembly creates sufficient power to lift heavy objects, and sufficient sensitivity to avoid harming patient. In some embodiments, the actuator assembly (200) provides the lifting arms compliance, safety, and flexibility to lift a heavy patient. In some embodiments, actuator assembly may include characteristics that include, without limit, inherent safety by limiting output force through use of compliance and force feedback actuation; and efficient to prolong battery life. Those skilled in the art, in light of the present teachings, will recognize that to ensure that medical robotic system does not drop the object if a power failure occurs, actuator assembly must be non-backdriveable. This requirement may be met by utilizing ball screws and harmonic drive system.

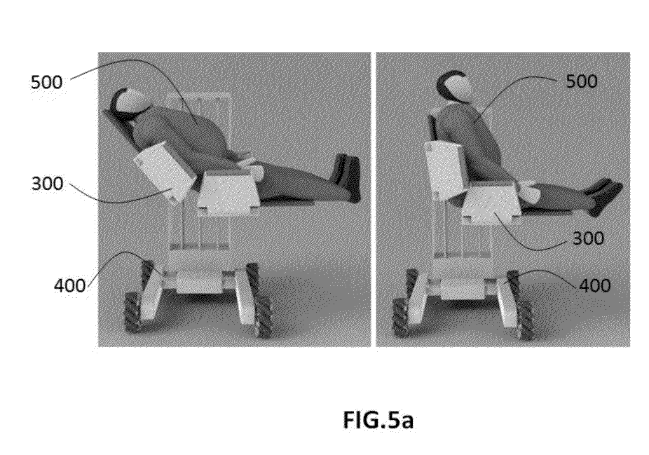

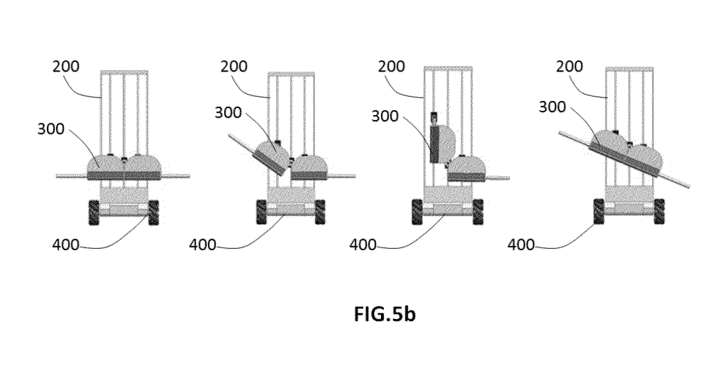

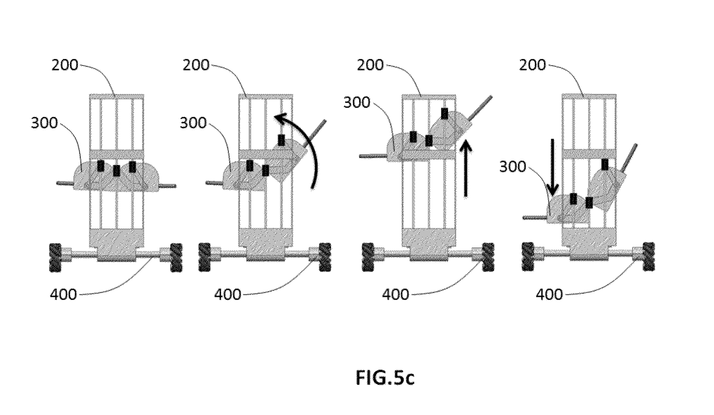

FIG. 5a illustrates the movement of linear actuators (210) relative to one another changing the vertical position and relative angle of the arms (300), in accordance with an embodiment of the present invention. Moving the linear actuators (210) relative to one another changes the vertical position and relative angle of the arms while at the same time ensuring that the arms are always at a fixed distance from a central pivot point.

FIG. 5b illustrates that the patient's position can be changed safely and comfortably from prone, to tilted, to reclined, to sitting at a 90 degree angle. By properly aligning the pivot point coincident with the patient's hips, all relative motion between the patient and the arms is eliminated when adjusting patient position.,

FIG. 5c illustrates the linear actuators (210) allows the robot to lift and lower the patient using the power of all three actuators combined once the patient is in the desired position.

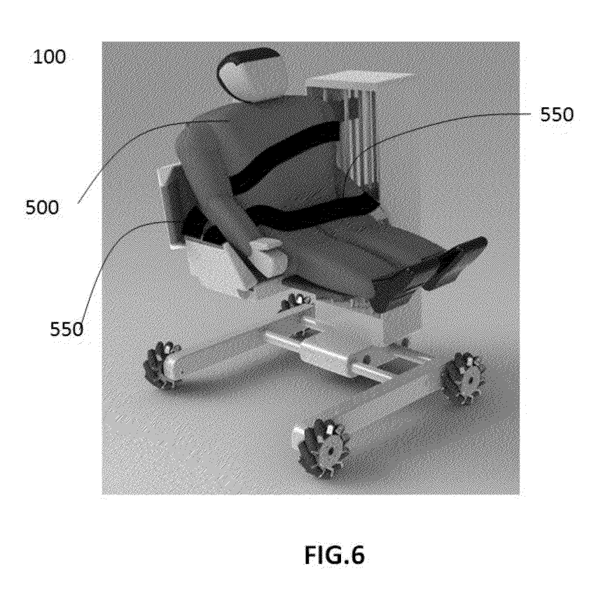

FIG. 6 illustrates safety straps (550) to secure the patient (500) and prevent him or her from sliding off the device (100). Such straps would need to be quite strong and wide, e.g., cloth-and-velcro strapping that is “laced” through a slits along the outer edges of the arms and extension surfaces.

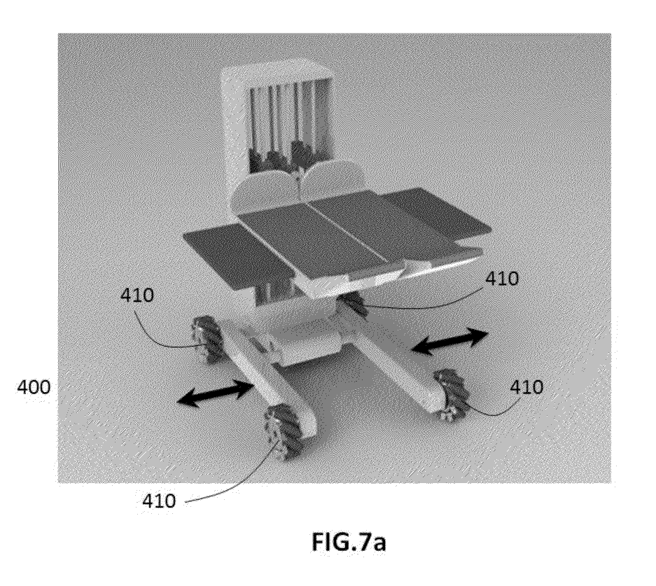

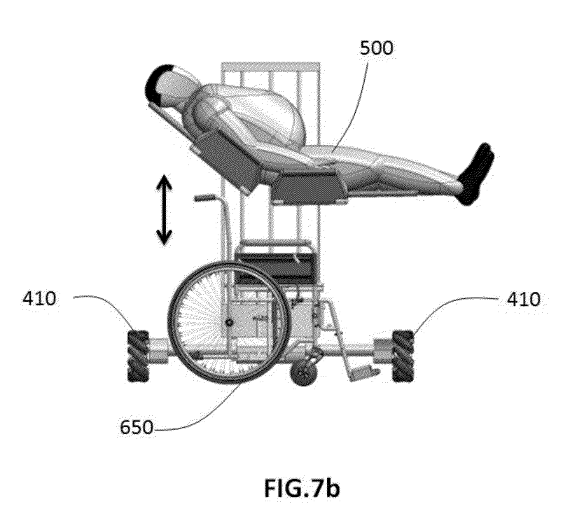

FIG. 7a illustrates low profile, small footprint, omnidirectional mobile base (400) which lifting mechanism is mounted on. In the present embodiment, the mobile base (400) provides a foundation for the medical robotic system. In some embodiments, it utilizes four independently driven mecanum wheels (410). This allows the base (400) to travel in any direction independent of rotation. To position itself in tight spaces, the robot has the ability to turn in place as well as strafe sideways.

Medical robotic system may increase the base with a stability enhancement device on the drive train to ensure secure lifting and transferring of patient. A pair of dexterous manipulators may lift the patient with sufficient torque so that up to, but not limited to 1,000 pounds may be lifted.

In some embodiments, drive track may navigate intelligently through a medical facility, including without limit tight spaces in proximity to a bed, with unique perceptive software and a holonomic drive. Those skilled in the art, in light of the present teachings, will recognize that a holonomic drive is useful for situations requiring higher mobility and lower fraction than a standard drive system. The holonomic drive allows drive track to translate in any direction, independent of rotation. This movement may utilize, without limitation, omni-wheels or mecanum wheels.

FIG. 7b illustrates a detailed perspective view of an exemplary drive track that expands to provide access to, but not limited to, wheelchair (650) or toilet tub while transferring the patient (500), in accordance with an embodiment of the present invention. In the present embodiment, by expanding the dimensions of base (400), a larger foundation for drive track creates increased stability for medical robotic system. This may be beneficial for supporting heavy objects. Drive track utilizes zero moment point control for enhanced stability. Zero moment point specifies a point with respect to a dynamic reaction force at the contact of the drive train with the ground does not produce any moment in the horizontal direction, i.e. the point where total of vertical inertia and gravity forces equals zero. In the present embodiments, it is this point that may produce the greatest stability, and medical robotic system may intelligently recognize this point.

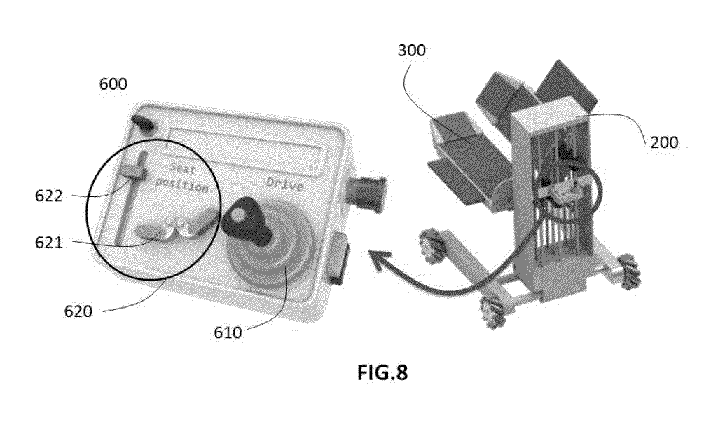

FIG. 8 illustrates an operation control unit (600), in accordance with an embodiment of the present invention. In the present embodiment, the control unit (600) is composed of two parts: controls for moving the platform around (610) and the control for the lifting arms (620). The operation control unit (600) will be mounted on the frame (200). To make the lifting arms (300) intuitive to operate, the position selector switches (621) on the control unit look like the lifting arms (300) and are directly coupled to the position and orientation of the lifting arms (300). Simply adjusting the levers (621) on the operation control unit will control the robot to move its arms (300) accordingly. The vertical slider (620) moves the arms up and down holding the selected position. Moving the joystick (610) forward moves the robot forward; sideways move it sideways; rotating it rotates the robot. The operation control unit is designed such that it is able to be removed from the frame (200). This allows a caregiver to maneuver the robot precisely from a distance if there are space constraints directly behind the robot. It also allows the possibility for the patient to take control of the robot him/herself.

In the present embodiment, a caregiver (900) may maneuver the medical robotic system precisely using an operation control unit. In one alternative embodiment, a patient may take control of the medical robotic system by means of voice command or an operation control unit. In some embodiments, the medical professional may transmit instructions to medical robotic system to approach and lift the patient.

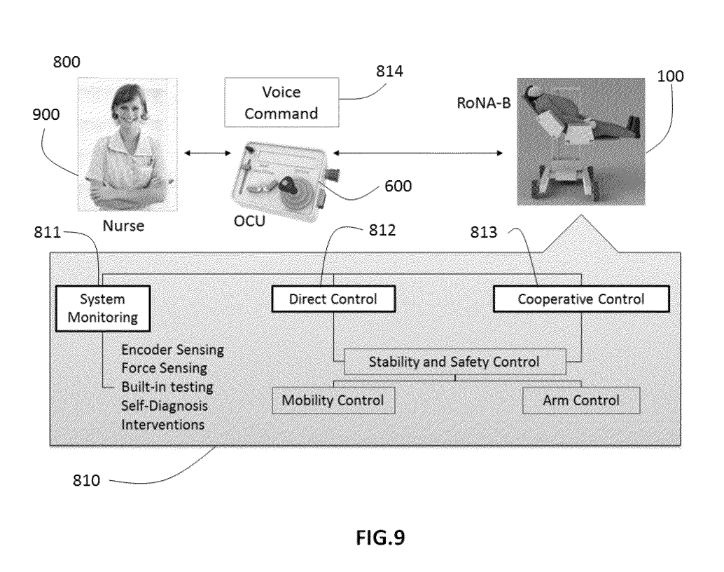

FIG. 9 illustrates the modular, extensible system framework (800), in accordance with an embodiment of the present invention. In the present embodiment, the control system allows for efficient integration of 3rd party systems such as hospital logistics management, real-time control OS, and sensor acquisition. The robot primary control subsystems (810) include a ‘system monitoring module’ (811), a ‘direct control’ (812), and a ‘cooperative control’ (813).

In the present embodiment, medical robot is controlled directly by an operation control unit (600). In some alternative embodiments, medical robotic system may utilize speech recognition software to recognize the caregiver's (900) voice command. A voice recognition system will allow the robot to initiate tasks at the nurse's request. And an onboard speech-synthesis system will allow the robot to confirm the desired task. It will allow patient-issued commands to operate the robot at a nursing home. In yet another alternative embodiment, the nurse (900) guides and adjusts the lifting arms to a desired location by a built-in haptic feedback control.

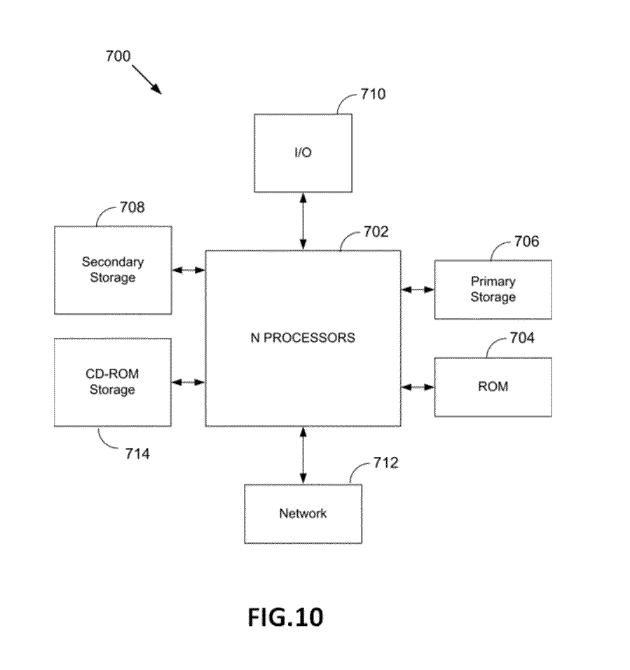

FIG. 10 illustrates a typical computer system that, when appropriately configured or designed, can serve as a computer system in which the invention may be embodied. The computer system 700 includes any number of processors 702 (also referred to as central processing units, or CPUs) that are coupled to storage devices including primary storage 706 (typically a random access memory, or RAM), primary storage 704 (typically a read only memory, or ROM). CPU 702 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 704 acts to transfer data and instructions uni-directionally to the CPU and primary storage 706 is used typically to transfer data and instructions in a bi-directional manner. Both of these primary storage devices may include any suitable computer-readable media such as those described above. A mass storage device 708 may also be coupled bi-directionally to CPU 702 and provides additional data storage capacity and may include any of the computer-readable media described above. Mass storage device 708 may be used to store programs, data and the like and is typically a secondary storage medium such as a hard disk. It will be appreciated that the information retained within the mass storage device 708, may, in appropriate cases, be incorporated in standard fashion as part of primary storage 706 as virtual memory. A specific mass storage device such as a CD-ROM 714 may also pass data uni-directionally to the CPU.

In the overall present embodiment, a caregiver directs the medical robot system by using an operation control unit (600) to 1) transfer a bariatric patient without using a sling; 2) transport a bariatric patient without an overhead hoist and ceiling tracks; and 3) transfer a bariatric patient from a bed to a standard wheelchair.

In some alternative embodiments, the medical robotic system allows patient self-operation to take control of the robot independently on their own functional level as robot can assist the movement as required.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing medical services to patients in a health care facility through a medical robot according to the present invention will be apparent to those skilled in the art. Various aspects of the invention have been described above by way of illustration, and the specific embodiments disclosed are not intended to limit the invention to the particular forms disclosed. The particular implementation of the medical robotic system may vary depending upon the particular context or application. By way of example, and not limitation, the medical robotic system described in the foregoing were principally directed to assisting a nurse by lifting the patient, communicating with the patient through telepresence interface, and maneuvering through a medical facility. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A robotic system comprising:
a vertical linear actuator unit being joined to said drive track unit, said vertical linear actuators comprising at least three actuator assemblies;
at least two lifting manipulation arms being joined to said vertical actuator assembly unit in which said vertical actuator assembly imparts torque and movement to said bimanual manipulation arms for lifting a heavy object, each of said arms comprising a conveyor belt surface;
a drive track unit being operable for moving the robotic system along a floor; and
at least one controlling unit being configured for operating a mobile platform and lifting manipulation arms;

2. The robotic system as recited in claim 1, in which said vertical linear actuator unit is further configurable for various bariatric patient handlings, such as lifting a bariatric patient from a bed and transferring a patient to a standard wheelchair.

3. The robotic system as recited in claim 2, in which said vertical linear actuator unit further comprises at least three linear actuators to move relative to one another to change the vertical position and relative angle of the arms.

4. The robotic system as recited in claim 2, in which said vertical linear actuators further comprise a plurality of linkages being joined to said manipulation arms.

5. The robotic system as recited in claim 4, in which said manipulation arm is configurable horizontally with the patient at bed level to slide under the patient and to lift the patient.

6. The robotic system as recited in claim 4, in which said manipulation arm further comprises said gentle conveyer belts that eliminate any relative motion between the patient's skin and the surface of the arm.

7. The robotic system as recited in claim 4, in which said manipulation arm further comprises an articulated flipper that rotates up to provide a secure safety stop when the patient is fully on the arms.

8. The robotic system as recited in claim 7, in which said articulated flipper is configured to be removable and replaced by another extreme end comprising a different structure.

9. The robotic system as recited in claim 4, in which said manipulation arm further comprises extension surfaces that emerge from the outward sides of the arms to support the patient's neck and legs.

10. The robotic system as recited in claim 4, in which said manipulation arms further comprises a fabric efficacious for providing sensitive contact with human skin.

11. The robotic system as recited in claim 1, in which said drive track unit is further configured to increase its dimensions to increase stability of the medical robotic system while lifting objects.

12. The robotic system as recited in claim Error! Reference source not found., in which said drive track unit is further configured to be holonomic.

13. The robotic system as recited in claim 11, in which said drive track unit further comprises a plurality of mecanum wheels.

14. The robotic system as recited in claim 1, in which said controlling unit further comprises two parts: controls for moving the platform around and the control for the lifting arms.

15. The robotic system recited in claim 14, in which said control for moving the platform utilizes a single operation control unit, moving the operation control unit forward to move the robot forward, moving it sideway to move the robot sideways; rotating it to rotate the robot.

16. The robotic system recited in claim 14, in which said control for lifting arms utilizes the position selector switches, looking like the lifting arms and directly coupled to the position and orientation of the lifting arms.

17. A robotic system comprising:
means for operating the robotic system for a heavy patient lifting and transferring;
means, being joined to said operating means, for imparting torque and movement;
means, receiving said torque and movement, being configured for moving an adult patient's lower body; and
means for moving the robotic system along a floor;

18. The robotic system as recited in claim 17, further comprising means, being joined to said moving means, for increasing stability of the medical robotic system while lifting objects.

19. The robotic system as recited in claim 17, further comprising means for remote operation by caregiver or user.

20. The robotic system as recited in claim 17, further comprising means for adjusting a width of said drive track means for stability and transferring a patient to a standard wheelchair.
